(19) United States
(12) Patent Application Publication
(10) Pub. No.: US 2018/0043539 A1
(43) Pub. Date: Feb. 15, 2018

(54) ROBOT, METHOD OF CONTROLLING THE ROBOT, AND METHOD OF ASSEMBLING WORKPIECE, AND METHOD OF CONVEYING WORKPIECE

(71) Applicant: KAWASAKI JUKOGYO KABUSHIKI KAISHA, Kobe-shi, Hyogo (JP)

(72) Inventors: Masayuki KAMON, Akashi-shi (JP); Takashi KIMURA, Kobe-shi (JP)

(73) Assignee: KAWASAKI JUKOGYO KABUSHIKI KAISHA, Kobe-shi, Hyogo (JP)

(21) Appl. No.: 15/558,090

(22) PCT Filed: Mar. 4, 2016
(86) PCT No.: PCT/JP2016/001209

§ 371 Date: Sep. 13, 2017

(30) Foreign Application Priority Data
Mar. 13, 2015 (JP) 2015-051434

(51) Int. Cl. B25J 9/16; G05B 15/02

(52) U.S. Cl. CPC B25J 9/1687; G05B 15/02

(57) ABSTRACT

A robot is provided, includes a hand configured to hold a workpiece, a floating unit having a tip-end part and a base-end part and having a joint configured to operate within a given operating range, the hand being attached to the tip-end part, and the tip-end part being movable with the base-end part, a robot arm is attached to the base-end part of the floating unit and configured to move the hand and the floating unit, and a control device having a robot arm controller configured to control operation of the robot arm. The robot arm controller moves the hand and the floating unit so that the hand is located at a temporary target position. The temporary target position is the hand movable to a target position by moving the tip-end part of the floating unit with the base-end part thereof, the tip-end part located at the temporary target position.

### TECHNICAL FIELD

The present disclosure relates to a robot, a method of controlling the robot, a method of assembling a workpiece, and a method of conveying the workpiece.

### BACKGROUND ART

Conventionally, work assisting systems which assist works in a factory production line have been known (e.g., see Patent Document 1).

The work assisting systems include an industrial robot having a holding part which holds a component, a motion capture device which measures and transmits a manual work operation by a worker sequentially with time, a pressure sensor which detects and transmits a pressure applied to the worker's fingertip(s), a controller which controls the industrial robot based on data transmitted from the motion capture device and the pressure sensor. Thus, the controller controls the industrial robot with a similar work operation to the worker's manual work operation based on the data transmitted from the motion capture and the pressure sensor. Thereby, the component is movable to a component assembling position with substantial accuracy.

### REFERENCE DOCUMENT OF CONVENTIONAL ART

### Patent Document

[Patent Document 1] JP2011-156641A

### DISCLOSURE

### Problems to be Solved by the Disclosure

However, the work assisting system disclosed in Patent Document 1 has a problem that the worker needs to go to the place where the component is placed.

### SUMMARY OF THE DISCLOSURE

According to one aspect of the present disclosure, a robot is provided, which includes a hand configured to hold a workpiece, a floating unit having a tip-end part and a base-end part and having a joint configured to operate within a given operating range, the hand being attached to the tip-end part, and the tip-end part being relatively movable with respect to the base-end part, a robot arm of which a tip-end part is attached to the base-end part of the floating unit and configured to move the hand and the floating unit, and a control device having a robot arm controller configured to control operation of the robot arm. The robot arm controller moves the hand and the floating unit so that the hand is located at a temporary target position. The temporary target position is a position from which the hand is movable to a target position by relatively moving the tip-end part of the floating unit with respect to the base-end part thereof, the tip-end part located at the temporary target position.

According to this configuration, since the hand can be located at the temporary target position near the target position by the robot alone, the burden on a worker can be reduced.

In addition, since the worker can operate the floating unit to move the hand from the temporary target position to the target position, the hand can be located at the target position even if the target position varies.

The floating unit may have a plurality of joints configured to operate within the given operating range, and the tip-end part may be relatively movable with respect to the base-end part with two or more degrees of freedom.

According to this configuration, the worker can manually move the hand located at the temporary target position in the direction of at least one degree-of-freedom to explore the target position, and the worker can manually move the hand in the direction of another degree-of-freedom so that the hand is located at the target position. Therefore, after the worker tunes finely the position of the hand which requires experience and sense of a worker, the hand can be located at the target position.

The robot may further include a fixing mechanism configured to regulate operation of the joint by being active and permit the operation of the joint by being inactive. The control device may have a fixing mechanism controller configured to control operation of the fixing mechanism. The fixing mechanism controller may activate the fixing mechanism when the robot arm controller moves the hand and the floating unit so that the hand is located at the temporary target position.

According to this configuration, the movement of the tip-end part of the floating unit can be prevented while the floating unit is moved by the robot arm.

The fixing mechanism may move the tip-end part of the floating unit by being active so that the floating unit takes a given posture, and maintain the given posture.

According to this configuration, an accurate positioning of the hand can be achieved.

The floating unit may include a limit position arrival detecting part configured to detect that the joint reaches a limit position of a given section within the given operating range. The fixing mechanism controller may deactivate the fixing mechanism after the robot arm controller moves the hand to the temporary target position, and in a state where the fixing mechanism is deactivated, when the limit position arrival detecting part detects that the joint reaches the limit position of the movable range, the robot arm controller may move the base-end part of the floating unit in a moving direction of the tip-end part of the floating unit by a given distance.

According to this configuration, the tip-end part of the floating unit can be moved outside the moving range of the tip-end part of the floating unit at the time of moving the hand so that the hand is located at the temporary target position.

The workpiece may be a component assembled to a product. The target position may be a position at which the component is located in a state where the component is assembled to the product.

According to this configuration, the robot can be applied to a production line of assembling products.

The joint of the floating unit may have a degree of freedom in the gravity direction. The floating unit may have a balancer configured to exert a force in the joint in a direction opposite from a force exerted in the joint by gravity.

According to this configuration, the hand and the workpiece held by the hand can easily be raised and lowered.

According to one aspect of the present disclosure, a method of controlling a robot is provided. The robot includes a hand configured to hold a workpiece, a floating unit having a tip-end part and a base-end part and having a joint configured to operate within a given operating range, the hand being attached to the tip-end part, and a tip-end part being relatively movable with respect to the base-end part, a robot arm of which a tip-end part is attached to the base-end part of the floating unit and configured to move the hand and the floating unit, and a control device having a robot arm controller configured to control operation of the robot arm. The robot arm controller moves the hand and the floating unit so that the hand is located at a temporary target position. The temporary target position is a position from which the hand is movable to a target position by relatively moving the tip-end part of the floating unit with respect to the base-end part thereof, the tip-end part located at the temporary target position.

According to this configuration, since the hand can be located at the temporary target position near the target position by the robot alone, the worker's burden can be reduced.

In addition, since the worker can operate the floating unit to move the hand from the temporary target position to the target position, the hand can be located at the target position even if the target position varies.

The floating unit may have a plurality of joints configured to operate within the given operating range, and the tip-end part may be relatively movable with respect to the base-end part with two or more degrees of freedom.

According to this configuration, the worker can manually move the hand located at the temporary target position in the direction of at least one degree-of-freedom to explore the target position, and the worker can manually move the hand in the direction of another degree-of-freedom so that the hand is located at the target position. Therefore, after the worker tunes finely the position of the hand which requires experience and sense of a worker, the hand can be located at the target position.

The robot may further include a fixing mechanism configured to regulate operation of the joint by being active and permit operation of the joint by being inactive. The control device may have a fixing mechanism controller configured to control operation of the fixing mechanism. The fixing mechanism controller may activate the fixing mechanism when the robot arm controller moves the hand and the floating unit so that the hand is located at the temporary target position.

According to this configuration, the movement of the tip-end part of the floating unit can be prevented while the floating unit is moved by the robot arm.

The fixing mechanism may move the tip-end part of the floating unit by being active so that the floating unit takes a given posture, and maintain the given posture.

According to this configuration, the accurate positioning of the hand can be achieved.

The floating unit may include a limit position arrival detecting part configured to detect that the joint reaches a limit position of a given section within the given operating range. The fixing mechanism controller may deactivate the fixing mechanism after the robot arm controller moves the hand to the temporary target position, and in a state where the fixing mechanism is deactivated, when the limit position arrival detecting part detects that the joint reaches the limit position of the movable range, the robot arm controller may move the base-end part of the floating unit in a moving direction of the tip-end part of the floating unit by a given distance.

According to this configuration, the tip-end part of the floating unit can be moved outside the moving range of the tip-end part of the floating unit at the time of moving the hand so as to locate at the temporary target position.

The workpiece may be a component assembled to a product. The target position may be a position at which the component is located in a state where the component is assembled to the product.

According to this configuration, the robot can be applied to the production line of assembling products.

The joint of the floating unit may have a degree of freedom in the gravity direction, and the floating unit may have a balancer configured to exert a force in the joint in a direction opposite from a force exerted in the joint by gravity.

According to this configuration, the hand and the workpiece held by the hand can easily be raised and lowered.

According to one aspect of the present disclosure, a method of assembling a workpiece to an assembling object by using a robot is provided. The robot includes a hand configured to hold a workpiece, a floating unit having a tip-end part and a base-end part and having a joint configured to operate within a given operating range, the hand being attached to the tip-end part, and the tip-end part being relatively movable with respect to the base-end part, a robot arm of which a tip-end part is attached to the base-end part of the floating unit and configured to move the hand and the floating unit, and a control device having a robot arm controller configured to control the robot arm. The robot arm controller moves the hand and the floating unit so that the hand is located at a temporary target position. By a worker relatively moving the tip-end part of the floating unit with respect to the base-end part, the workpiece held by the hand located at the temporary target position is moved to a destination of the workpiece and is assembled to the assembling object.

According to this configuration, since the hand can be located at the temporary target position near the target position by the robot alone, the worker's burden can be reduced.

In addition, since the worker can operate the floating unit to move the hand from the temporary target position to the target position, the hand can be located at the target position even if the target position varies.

According to one aspect of the present disclosure, a method of conveying a workpiece located at a given position by using a robot is provided. The robot includes a hand configured to hold a workpiece, a floating unit having a tip-end part and a base-end part and having a joint configured to operate within a given operating range, the hand being attached to the tip-end part, and the tip-end part being relatively movable with respect to the base-end part, a robot arm of which a tip-end part is attached to the base-end part of the floating unit and configured to move the hand and the floating unit, and a control device having a robot arm controller configured to control the robot arm. The robot arm controller moves the hand and the floating unit so that the hand is located at a temporary target position. A worker relatively moves the tip-end part of the floating unit with respect to the base-end part to move the hand located at the temporary target position to the given position, and causes the hand to hold the workpiece. The robot arm controller moves the hand and the floating unit to convey the workpiece held by the hand.

According to this configuration, since the hand can be located at the temporary target position near the target position by the robot alone, the worker's burden can be reduced.

In addition, since the worker can operate the floating unit to move the hand from the temporary target position to the target position, the hand can be located at the target position even if the target position varies.

### Effects of the Disclosure

The present disclosure is capable of achieving an effect of reducing the worker's burden, and moving the hand to a target position even if the target position varies.

### BRIEF DESCRIPTION OF DRAWINGS

FIG. 1 is a view illustrating one example of a structure of a robot according to Embodiment 1 of the present disclosure.

FIG. 2 is a perspective view illustrating one example of a structure of a floating unit of the robot of FIG. 1.

FIG. 3 is a view schematically illustrating one example of the structure of the floating unit of the robot of FIG. 1.

FIG. 4 is a view schematically illustrating one example of a structure of a fixing mechanism of the robot of FIG. 1.

FIG. 5 is a block diagram schematically illustrating one example of a structure of a control system of the robot of FIG. 1.

FIG. 6 is a flowchart illustrating one example of operation of the robot of FIG. 1.

FIG. 7A is a view illustrating one example of operation of the robot of FIG. 1.

FIG. 7B is a view illustrating one example of operation of the robot of FIG. 1.

FIG. 7C is a view illustrating one example of operation of the robot of FIG. 1.

FIG. 7D is a view illustrating one example of operation of the robot of FIG. 1.

FIG. 7E is a view illustrating one example of operation of the robot of FIG. 1.

FIG. 8 is a perspective view illustrating one example of a structure of a floating unit of a robot according to Embodiment 2 of the present disclosure.

FIG. 9 is a view schematically illustrating one example of the structure of the floating unit of the robot of FIG. 8.

FIG. 10 is a block diagram schematically illustrating one example of a structure of a control system of the robot of FIG. 8.

FIG. 11 is a flowchart illustrating one example of operation of the robot of FIG. 1.

FIG. 12 is a view illustrating one example of operation of the robot of FIG. 1.

FIG. 13 is a flowchart illustrating one example of operation of a robot according to Embodiment 3 of the present disclosure.

### MODES FOR CARRYING OUT THE DISCLOSURE

### Aim of Present Disclosure

The present inventors have diligently examined an increase in efficiency of assembling a weighted component which is difficult for a worker to hold in a factory production line.

Conventionally, the work in which a weighted component placed in a component yard is carried to a position by the side of a product in a production line, and assembly of the weighted component to the product are performed, for example, according to the following procedure.

First, the worker moves a lifter into the component yard, and then ties the weighted component placed in the component yard with the lifter. The worker then operates the lifter to carry the weighted component from the component yard to the position by the side of the product in the production line. Next, the worker fits and assembles the component to the product.

Here, in the assembling of the component to the product in the production line, the worker may assemble the component to the product, after he/she grips and swings the component supported by the lifter to explore a fitting position of the component for a fine adjustment of the component position with respect to the product. Such a work is difficult for the conventional robot to perform because worker's experiences and senses influence the quality of work.

Thus, the present inventors have conceived of a robot, which includes a hand configured to hold a workpiece, a floating unit having a tip-end part and a base-end part. The hand is attached to the tip-end part. The floating unit includes a joint configured to operate within a given operating range and the tip-end part is capable of relatively moving with respect to the base-end part. The robot also includes a robot arm of which a tip-end part is attached to the base-end part of the floating unit, and is configured to move the hand and the floating unit, and a controlling device provided with a robot arm controller configured to control operation of the robot arm. The robot arm controller is configured to move the hand and the floating unit so that the hand is located at a temporary target position. The temporary target position is a position from which the tip-end part of the floating unit located at the temporary target position is relatively movable with respect to the base-end part in order to move the hand to a target position.

According to the present disclosure, since the hand can be located at the temporary target position near the target position by the robot alone, the worker's burden is reduced.

In addition, since the worker can operate the floating unit to move the hand from the temporary target position to the target position, the hand can be located at the target position even if the target position varies.

Hereinafter, embodiments of the present disclosure are described with reference to the accompanying drawings. Note that the present disclosure is not limited by the embodiments. Below, the same reference characters are assigned to the same or corresponding elements throughout the drawings to omit redundant description.

### Embodiment 1

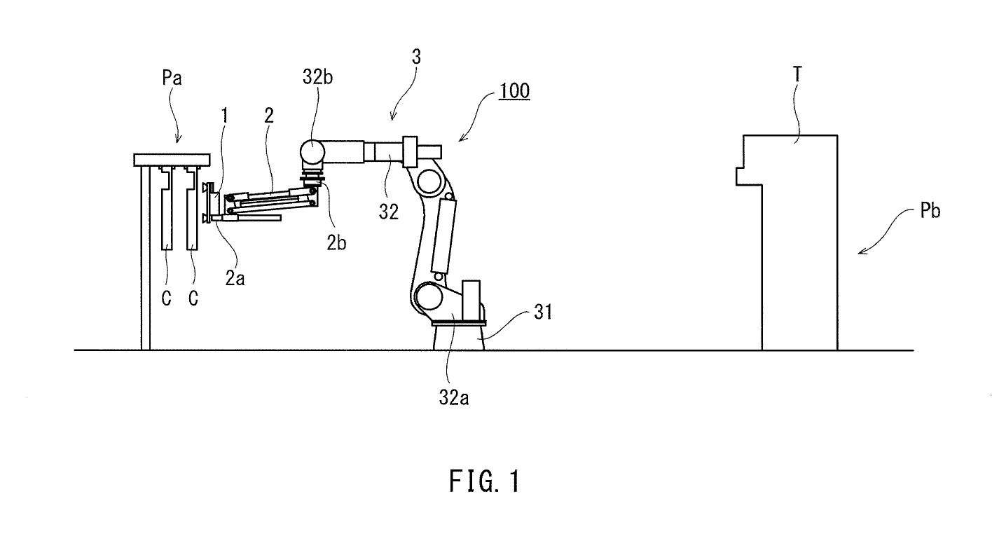

FIG. 1 is a view illustrating one example of a structure of a robot 100 according to Embodiment 1 of the present disclosure.

As illustrated in FIG. 1, the robot 100 is installed, for example, in a work place where a component C (workpiece) is assembled to a product T (e.g., a production line). That is, the component C is a member to be assembled to the product T (an assembling object).

In this production line, a pre-assemble storage area Pa of workpiece and an assembling area Pb are set (arranged) within an operating area of a hand 1 (described later) of the robot 100.

The pre-assemble storage area Pa is a place where the component C to be assembled to the product T is kept temporarily. In the pre-assemble storage area Pa, the components C are precisely arranged at given positions by being held on a shelf (not illustrated), and the positions of the components C held on the shelf are stored beforehand in a controller 60 of a control device 6 (described later).

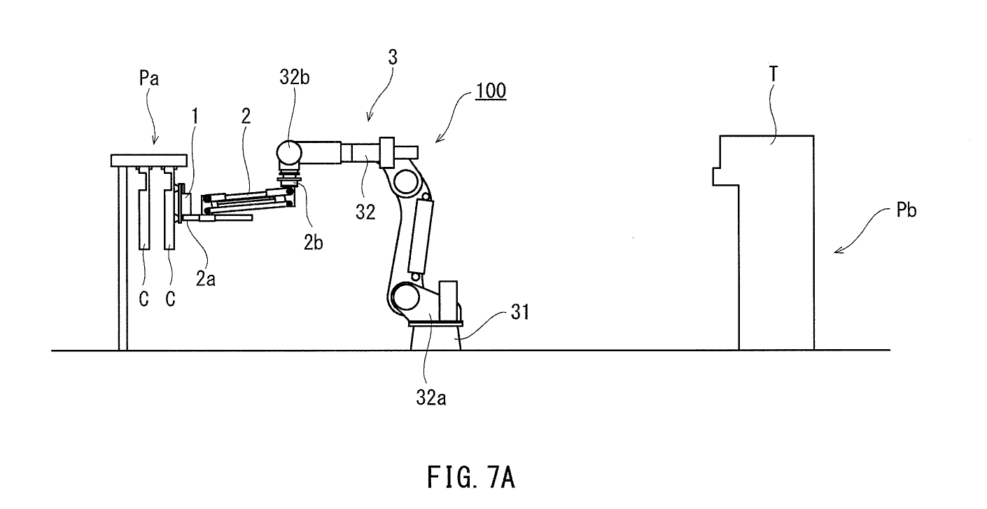

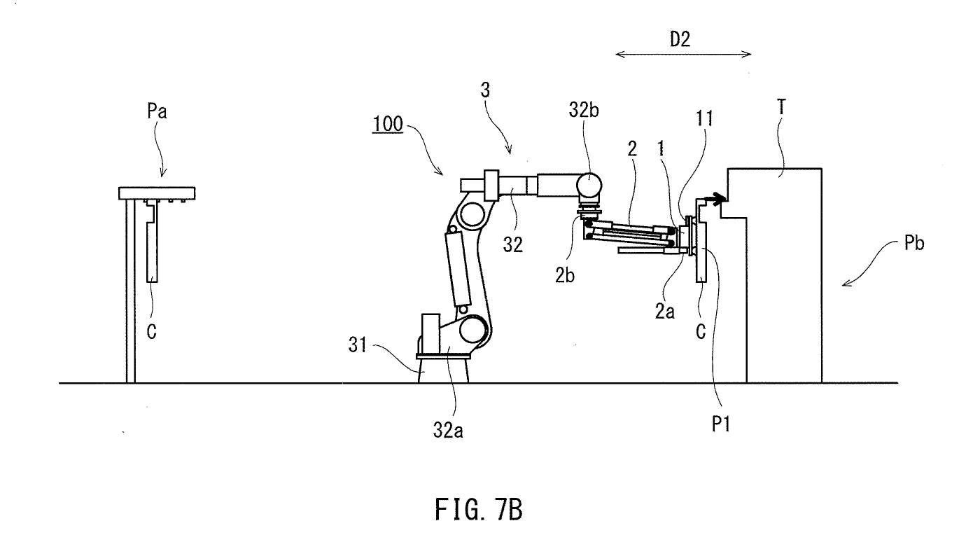

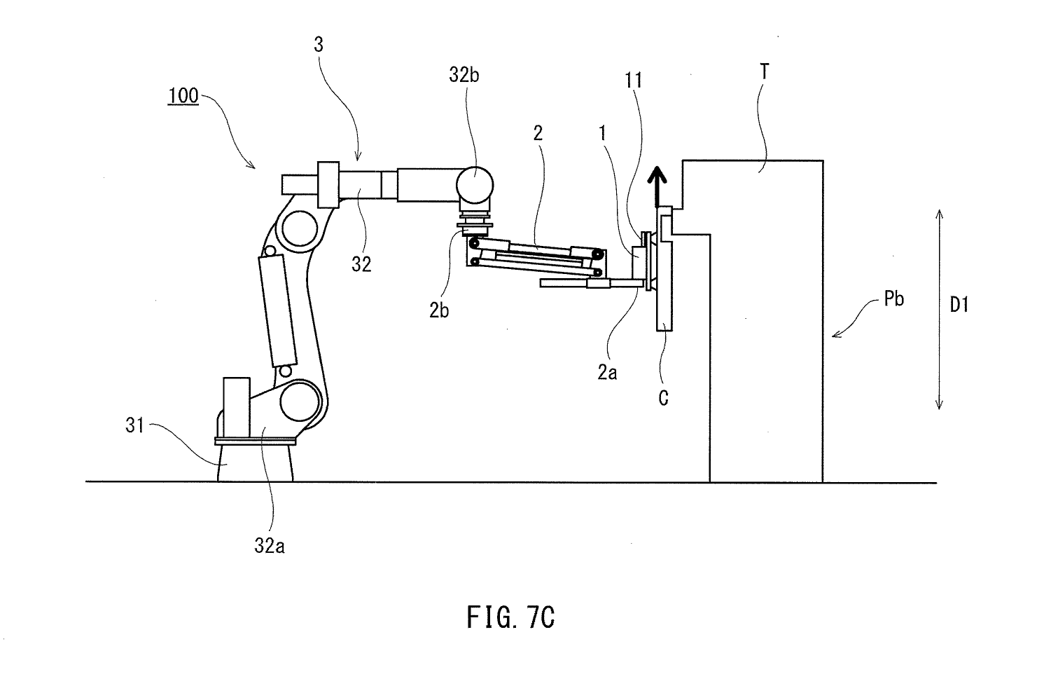

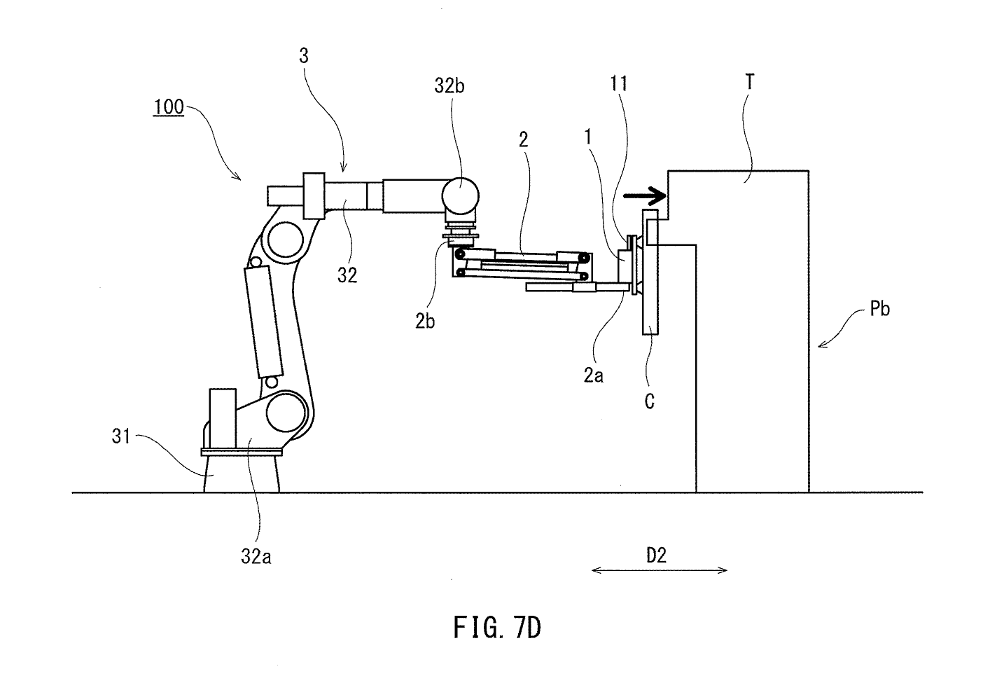

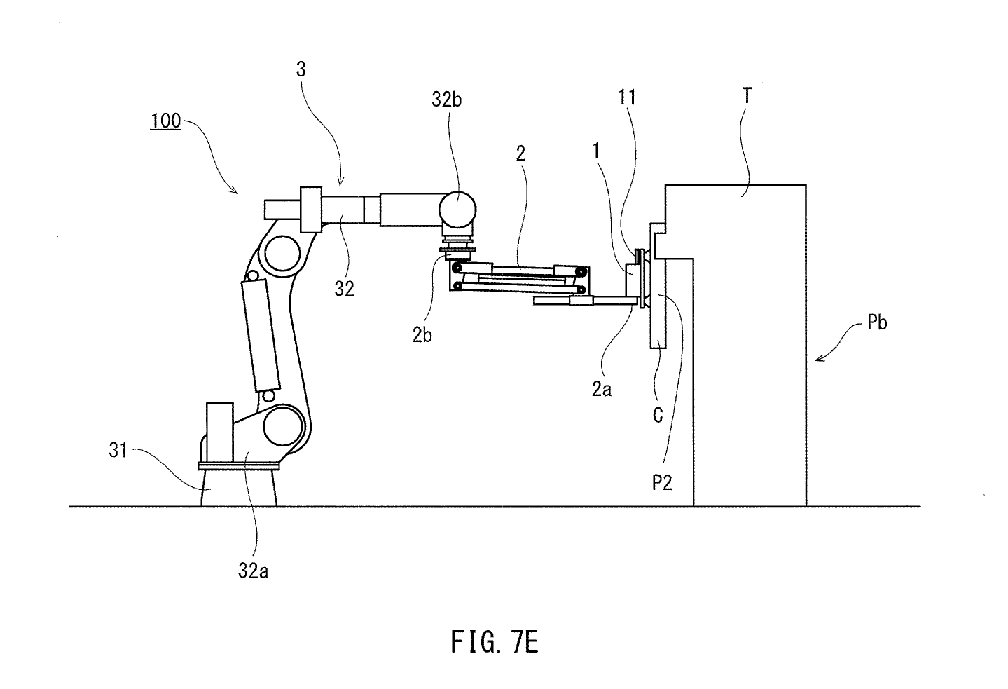

The assembling area Pb is a place where the component C is assembled to the product T. The product T is placed on the assembling area Pb. In a state where the component C is assembled to the product T placed on the assembling area Pb, a position at which the hand 1 and the component C held by the hand 1 are located constitutes a target position P2 (see FIG. 7E). A temporary target position P1 (see FIG. 7B) is set at a position from which the component C held by the hand 1 is movable to a target position P2 which is a destination of the component C by relatively moving a tip-end part 2a (a hand attaching part 21 described later) of a floating unit 2 with respect to a base-end part 2b (a robot-arm attaching part 26 described later). That is, the temporary target position P1 is set near the target position P2 so that it is set at the position from which the hand 1 (and the component C held by the hand 1) is movable to the target position P2 by relatively moving the tip-end part 2a of the floating unit 2 located at the temporary target position P1 to the base-end part 2b.

### Entire Structure of Robot

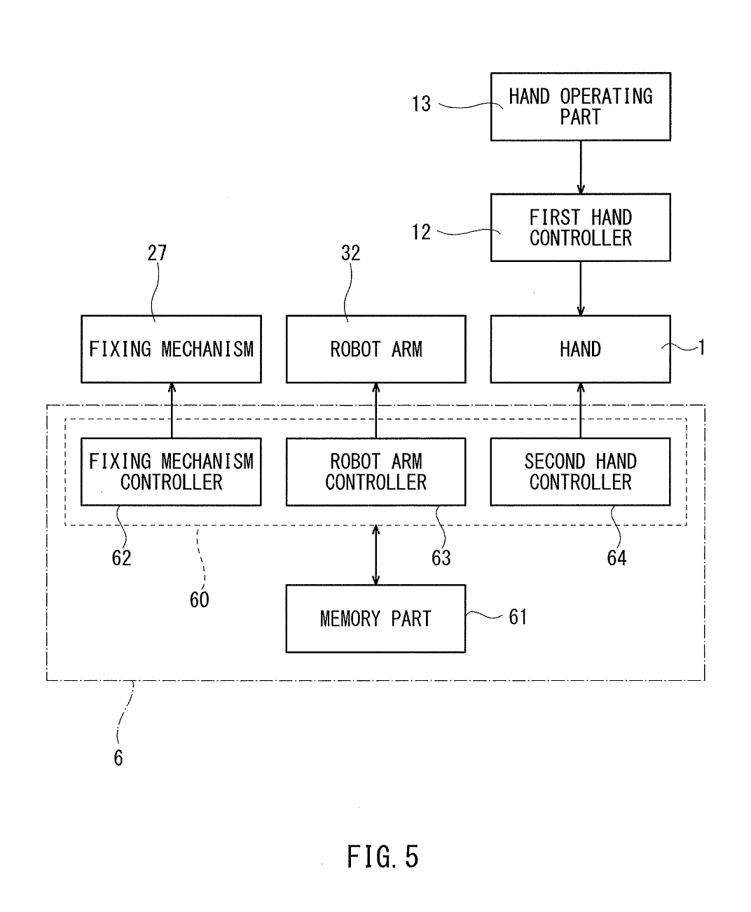

As illustrated in FIG. 1, the robot 100 includes the hand 1 which holds the workpiece, the floating unit 2, a robot body 3, and the control device 6 (see FIG. 5).

### Hand

The hand 1 is configured to perform a holding operation in which it holds the component C, and a releasing operation in which it releases the held object. The hand 1 is attached to the tip-end part 2a of the floating unit 2.

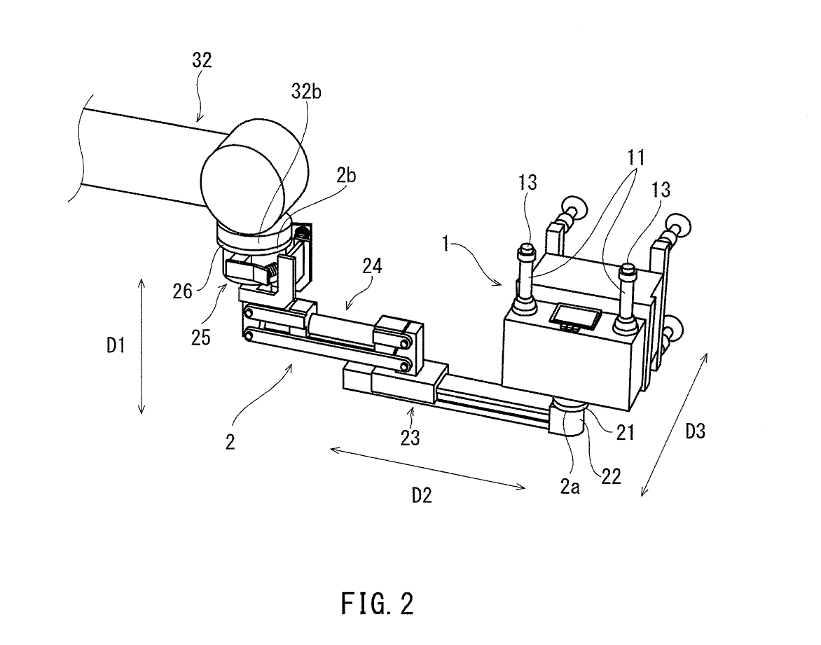

In this embodiment, the hand 1 is a device which adsorbs and holds the component C, and has an adsorption holding mechanism (not illustrated) which adsorbs and holds the component C and disables the adsorption holding of the component C by disabling the adsorption holding. The hand 1 includes handles 11 (see FIG. 2) which the worker grips and moves the hand 1, a first hand controller 12 (see FIG. 5), and hand operating parts 13 (see FIGS. 2 and 5). The first hand controller 12 controls the hand 1 so that it operates the hand 1 to perform the holding operation in which the hand 1 holds the component C and the releasing operation in which the hand 1 releases the component C. The hand operating parts 13 are configured to accept inputs of a holding instruction of the component C and a releasing instruction of the component C to the first hand controller 12, respectively.

### Robot Body

As illustrated in FIG. 2, the robot body 3 is, for example, an articulated industrial robot but it is not limited to this structure. The robot body 3 includes a robot base 31 and a robot arm 32.

The robot base 31 is a pedestal which is placed on a placement surface such as a floor surface of the production line in a state where it is not fixed to the placement surface, and it supports the robot arm 32, the floating unit 2, and the hand 1.

The robot arm 32 moves the floating unit 2 and the hand 1. The robot arm 32 is provided with, for example, a plurality of joints so that a base-end part 32a is rotatably coupled to the robot base 31. A tip-end part 32b of the robot arm 32 is attached to the base-end part 2b (the robot-arm attaching part 26 described later) of the floating unit 2. The robot arm 32 includes a robot arm actuator (not illustrated) which drives a plurality of joint axes.

### Floating Unit

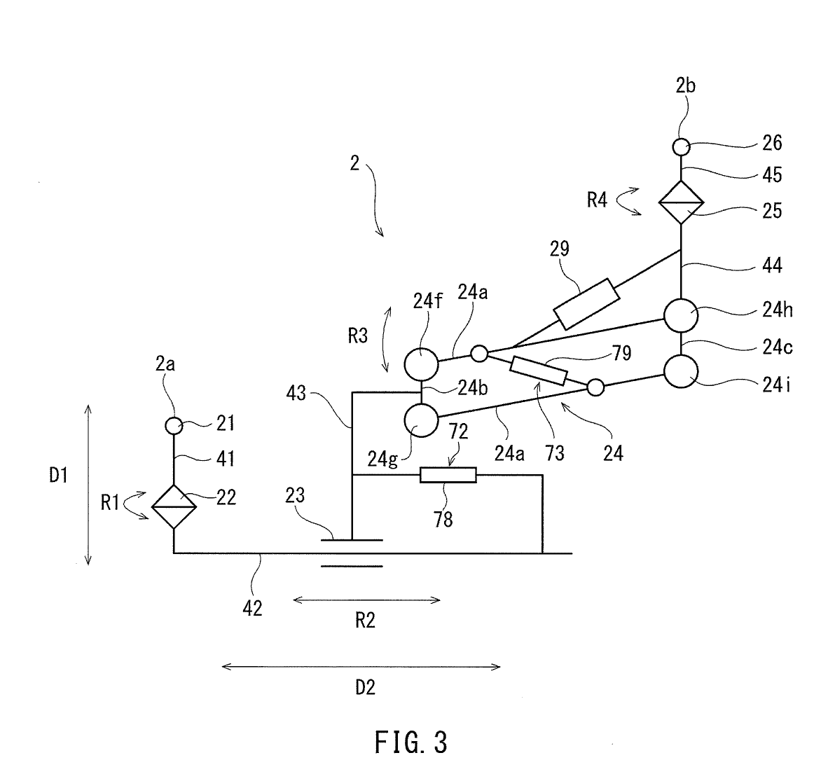

FIG. 2 is a perspective view illustrating one example of a structure of the floating unit 2. FIG. 3 is a view schematically illustrating one example of the structure of the floating unit 2.

As illustrated in FIGS. 2 and 3, the hand 1 is attached to the tip-end part of the floating unit 2. The floating unit 2 has joints which operate within a given operating range, and the tip-end part thereof is configured to be relatively movable with respect to the base-end part.

In this embodiment, as illustrated in FIG. 3, the floating unit 2 has the plurality of joints which operate within the given operating range, and the tip-end part 2a thereof is relatively movable with two or more degrees of freedom with respect to the base-end part 2b. The floating unit 2 includes, for example, the hand attaching part 21, a first joint part 22, a second joint part 23, a third joint part 24, a fourth joint part 25, the robot-arm attaching part 26, and first to fifth coupling pieces 41, 42, 43, 44 and 45 which sequentially couple these parts from the hand 1 to the robot arm 32 in a single-file manner. The floating unit 2 also includes a fixing mechanism 27.

The hand attaching part 21 is a part to which the hand 1 is attached.

The first joint part 22 couples the first coupling piece 41 with the second coupling piece 42 rotatably about an axis extending in first directions D1. The first directions D1 are, for example, vertical directions. The first coupling piece 41 is configured so as to be rotatable with respect to the second coupling piece 42 within a given operating range R1. That is, the first coupling piece 41 is coupled to the second coupling piece 42 via the first joint part 22 having a degree of freedom about the axis extending in the first directions D1.

The second joint part 23 couples the second coupling piece 42 to the third coupling piece 43 translatably in second directions D2 which intersect the first directions D1. The second directions D2 are directions which intersect, for example, perpendicularly with the first directions D1 (i.e., horizontal directions). The second coupling piece 42 is configured so as to be translatable with respect to the third coupling piece 43 within a given operating range R2. That is, the second coupling piece 42 is coupled to the third coupling piece 43 via the second joint part 23 having a degree of freedom in the second directions D2.

The third joint part 24 couples the third coupling piece 43 to the fourth coupling piece 44 pivotably in the first directions D1. The third coupling piece 43 is configured so as to be pivotable with respect to the fourth coupling piece 44 within a given operating range R3. That is, the third coupling piece 43 is coupled to the fourth coupling piece 44 via the third joint part 24 having a degree of freedom in the first directions D1 (parallel to the gravity direction).

In this embodiment, the third joint part 24 has a parallel link structure, and includes a pair of pivot links 24a extending parallel with each other, a tip-end side coupling part 24b which couples one ends of the pair of pivot links 24a, and a base-end side coupling part 24c which couples the other ends of the pair of pivot links 24a and extends parallel with the tip-end side coupling part 24b. One of the pair of pivot links 24a is coupled to the tip-end side coupling part 24b, the other pivot link 24a is coupled to the tip-end side coupling part 24b, one of the pair of pivot links 24a is coupled to the base-end side coupling part 24c, and the other pivot link 24a is coupled to the base-end side coupling part 24c, rotatably about axes extending in third directions D3 (parallel to an outward direction perpendicular to the drawing surface of FIG. 3; see FIG. 2) which intersect both the first directions D1 and the second directions D2 and, thus, the axes constitute first to fourth joints 24f, 24g, 24h and 24i, respectively. Therefore, when the tip-end part of the third joint part 24 is pivoted, the tip-end side coupling part 24b and the base-end side coupling part 24c are configured to be always pivotable while maintaining the distance therebetween and their postures.

The third coupling piece 43 is coupled to the tip-end side coupling part 24b, and the fourth coupling piece 44 is coupled to the base-end side coupling part 24c. Therefore, by pivoting the third joint part 24, the hand 1 coupled to the tip-end part of the third joint part 24, the hand attaching part 21, the first coupling piece 41, the first joint part 22, the second coupling piece 42, the second joint part 23, and the third coupling piece 43 are relatively raised and lowered with respect to the fourth coupling piece 44 coupled to the base-end part of the third joint part 24, the fourth joint part 25, a fifth coupling piece 45, and the robot-arm attaching part 26.

The third joint part 24 is provided with a balancer mechanism 29. The balancer mechanism 29 exerts on the third joint part 24 a force in a direction opposite from a force caused in the third joint part 24 by gravity. The balancer mechanism 29 generates, for example, a torque resisting a torque which is generated in the third joint part 24 by gravity acting on components etc. (e.g., the component C, the hand 1, the hand attaching part 21, the first coupling piece 41, the first joint part 22, the second coupling piece 42, the second joint part 23, and the third coupling piece 43) coupled to the tip-end part of the third joint part 24. Therefore, the worker can easily raise and lower the component C relatively to the tip-end part 32b of the robot arm 32.

The fourth joint part 25 couples the fourth coupling piece 44 to the fifth coupling piece 45 rotatably about an axis extending in the first directions D1. The fourth coupling piece 44 is configured to be rotatable with respect to the fifth coupling piece 45 within a given operating range R4. That is, the fourth coupling piece 44 is coupled to the fifth coupling piece 45 via the fourth joint part 25 having a degree of freedom about the axis extending in the first directions D1.

The robot-arm attaching part 26 is a part to which the tip-end part 32b of the robot arm 32 is attached.

Thus, since both the first joint part 22 and the fourth joint part 25 have a degree of freedom about the axis extending in the first directions D1, respectively, the floating unit 2 has degrees of freedom in the first directions D1 and the second directions D2. Therefore, the tip-end part 2a of the floating unit 2 is relatively movable in the first directions D1 and the second directions D2 with respect to the base-end part 2b.

Moreover, since the second joint part 23 has a degree of freedom in the second directions D2, it can relatively move the tip-end part 2a of the floating unit 2 more smoothly in the second directions D2 with respect to the base-end part 2b.

Furthermore, since the third joint part 24 has a degree of freedom in the first directions D1 (parallel in the gravity direction), the tip-end part 2a of the floating unit 2 can be raised and lowered in the first directions D1 relatively with respect to the base-end part 2b.

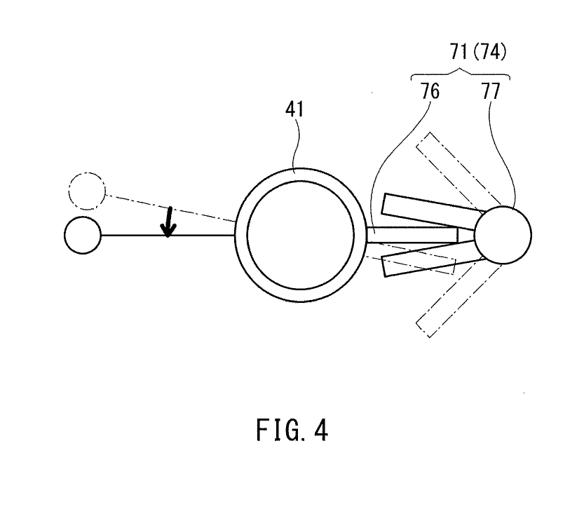

FIG. 4 is a view schematically illustrating one example of a structure of the fixing mechanism 27.

The fixing mechanism 27 is a mechanism which regulates operations of the joints of the floating unit 2 by being active, and permits the operations of the joints of the floating unit 2 by being inactive. That is, the fixing mechanism 27 regulates, by being active, the operations of the first to fourth joint parts 22, 23, 24 and 25 of the floating unit 2 to regulate the relative movement of the tip-end part 2a of the floating unit 2 with respect to the base-end part 2b. The fixing mechanism 27 regulates, by being inactive, the operations of the first to fourth joint parts 22, 23, 24 and 25 of the floating unit 2 to permit the relative movement of the tip-end part 2a of the floating unit 2 with respect to the base-end part 2b.

Moreover, the fixing mechanism 27 is a mechanism which relatively moves the tip-end part 2a of the floating unit 2 with respect to the base-end part thereof, by being active, so that the floating unit 2 takes and maintains a given posture. Therefore, in a state where the fixing mechanism 27 is activated, since a spatial relationship between the tip-end part 32b of the robot arm 32 and the hand 1 is fixed to a given spatial relationship, a robot arm controller 63 can identify the position of the hand 1. The temporary target position P1 is set to the position from which the hand is movable to the target position by disabling the fixing mechanism 27 of the floating unit 2 located at the temporary target position P1 in the state where the fixing mechanism 27 is activated, and relatively moving the tip-end part 2a of the floating unit 2 with respect to the base-end part 2b.

In this embodiment, the fixing mechanism 27 includes first to fourth fixing parts 71-74 (see FIG. 4 for the first fixing part 71 and the fourth fixing part 74) corresponding to the first to fourth joint parts 22, 23, 24 and 25. The first to fourth fixing parts 71-74 regulate, by being active, the operations of the corresponding joints after moving the joints to the given positions within the given operating range, and permit, by being inactive, the operations of the corresponding joint, respectively.

That is, the first coupling piece 41 is fixed at the given position within the given operating range R1 with respect to the second coupling piece 42 by the first fixing part 71 becoming active. For example, as illustrated in FIG. 4, the first fixing part 71 has an arm 76 of which a base-end part is attached to the first coupling piece 41 and which extends in a direction perpendicular to the extending direction of the rotational axis of the first joint part 22, and an arm pinching part 77 which is attached to the second coupling piece 42 and is configured to be openable and closable. Therefore, the arm 76 is pivoted by rotating the first joint part 22. The arm pinching part 77 is configured to pinch the tip-end part of the arm 76 by closing in order to regulate the pivoting of the arm 76. Thus, the first coupling piece 41 is regulated its operation with respect to the second coupling piece 42 after the first coupling piece 41 is located at the given position within the given operating range R1.

Moreover, the second coupling piece 42 is fixed, by the second fixing part 72 being active, at the given position within the given operating range R2 with respect to the third coupling piece 43. The second fixing part 72 is provided with an air cylinder mechanism 78 which relatively translates, by being active, a piston rod with respect to a cylinder. When the second coupling piece 42 is to be fixed to the third coupling piece 43, the piston rod of the air cylinder mechanism 78 is moved to translate the second coupling piece 42 in one of the first directions D1 with respect to the third coupling piece 43, locate the second coupling piece 42 at one of limit positions of the operating range R2, and bias the second coupling piece 42 in a direction toward the one of the limit positions from the other limit position. Thereby, the second coupling piece 42 is regulated its operation with respect to the third coupling piece 43 after the second coupling piece 42 is located at the given position within the given operating range R2.

Furthermore, the third coupling piece 43 is regulated its operation with respect to the fourth coupling piece 44 after the third coupling piece 43 is located at the given position within the given operating range R3, by the third fixing part 73 being active. Since the structure of the third fixing part 73 is similar to the structure of the second fixing part 72, detailed description thereof is omitted.

Moreover, the fourth coupling piece 44 is regulated its operation with respect to the fifth coupling piece 45, at the given position within the given operating range R4, by the fourth fixing part 74 being active. Since the structure of the fourth fixing part 74 is similar to the structure of the first fixing part 71, detailed description thereof is omitted.

### Control Device

FIG. 5 is a block diagram schematically illustrating one example of a structure of a control system of the robot 100.

As illustrated in FIG. 5, the control device 6 of the robot 100 includes the controller 60 and a memory part 61, and, for example, is comprised of a micro controller, a CPU, an MPU, a logic circuit, a PLC, etc. The control device may be comprised of a single control device which performs a centralized control, or may be comprised of a plurality of control devices which perform a distributed control.

The memory part 61 includes a memory, such as a ROM and/or a RAM. The memory part 61 stores information for identifying the position of the component C placed in the pre-assemble storage area Pa, and information for identifying the temporary target position P1, and information for identifying the position of the hand 1 in a state where a spatial relationship between the tip end of the robot arm 32 and the hand 1 is fixed to a given spatial relationship by the fixing mechanism 27.

The controller 60 includes a fixing mechanism controller 62, the robot arm controller 63, and a second hand controller 64. The fixing mechanism controller 62, the robot arm controller 63, and the second hand controller 64 are functional blocks which are implemented by a computing unit executing a given control program stored in the memory part 61. The robot arm controller 63 controls the robot arm 32. The second hand controller 64 controls the operation of the hand 1 to operate the hand 1 so that the hand 1 performs the holding operation and the releasing operation. The second hand controller 64 may control the hand 1 via the first hand controller 12. The fixing mechanism controller 62 controls the fixing mechanism 27.

### Example of Operation

Next, one example of operation of the robot 100 is described.

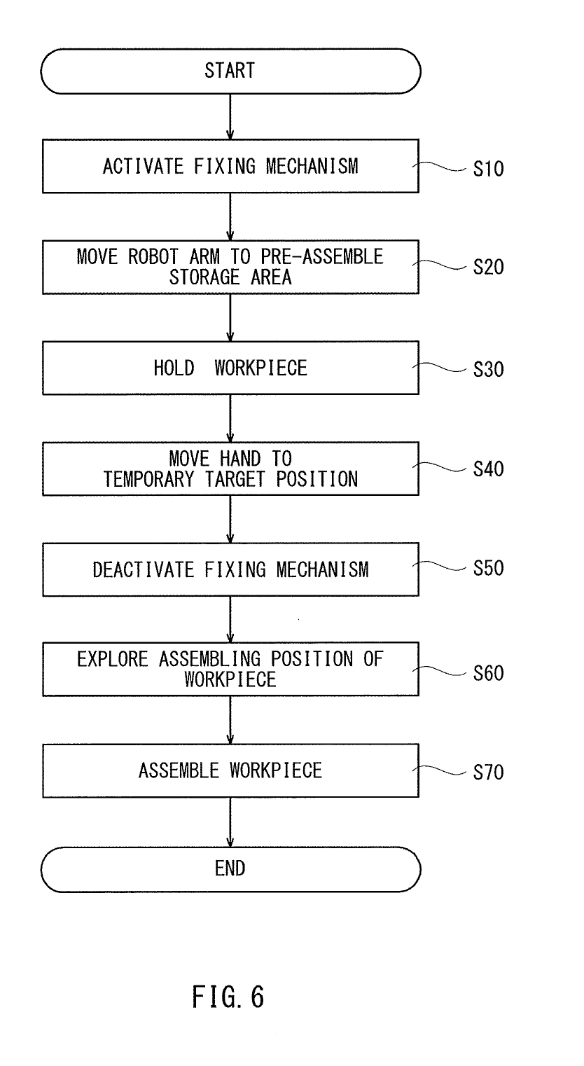

FIG. 6 is a flowchart illustrating the example of the operation of the robot 100. FIGS. 7A to 7E are views illustrating one example of the operation of the robot 100.

First, the fixing mechanism controller 62 enables the fixing mechanism 27 to regulate the relative movement of the tip-end part 2a of the floating unit 2 with respect to the base-end part 2b, and fix the spatial relationship between the tip end of the robot arm 32 and the hand 1, which are coupled via the floating unit 2, to the given spatial relationship (Step S10).

Next, as illustrated in FIG. 7A, the robot arm controller 63 controls the robot arm 32 to move the hand 1 to the position at which the component C is placed in the pre-assemble storage area Pa based on the information for identifying the position of the component C placed in the pre-assemble storage area Pa stored in the memory part 61 (Step S20).

Next, the second hand controller 64 controls the hand 1 to hold the component C by the hand 1 (Step S30).

Next, as illustrated in FIG. 7B, the robot arm controller 63 controls the robot arm 32 to move the hand 1 and the floating unit 2 based on the information for identifying the temporary target position P1 stored in the memory part 61 so that the hand 1 is located at the temporary target position P1 (Step S40). As described above, the temporary target position P1 is set as the position from which the hand 1 is movable to the target position P2 by relatively moving the tip-end part 2a of the floating unit 2 located at the temporary target position P1 with respect to the base-end part 2b. However, the hand 1 may not be movable to the target position P2 by relatively moving the tip-end part 2a of the floating unit 2 located at the temporary target position P1 with respect to the base-end part 2b, due to an error etc. in the position of the product T placed in the assembling area Pb.

Thus, since the component C can be conveyed by the robot 100 from the pre-assemble storage area Pa to the temporary target position P1 which is set near the target position P2, the worker's burden is reduced and the work efficiency is increased.

Moreover, when the fixing mechanism 27 is activated at Step S10, and the robot arm controller 63 moves the hand 1 and the floating unit 2 so that the hand 1 is located at the temporary target position P1, since the fixing mechanism 27 is activated, and each operation of the plurality of joints of the floating unit 2 is regulated, the movement of the tip-end part 2a of the floating unit 2 is prevented while the floating unit 2 is moving. Moreover, since the spatial relationship between the tip end of the robot arm 32 and the hand 1, which are coupled via the floating unit 2, is fixed to the given spatial relationship, the hand 1 and the component C held by the hand 1 can accurately be located at the temporary target position P1. Furthermore, the robot 100 can be prevented from contacting, for example, the product T.

Next, the fixing mechanism controller 62 disables the fixing mechanism 27 (Step S50). Thereby, the tip-end part 2a of the floating unit 2 is permitted to relatively move with respect to the base-end part 2b, and it is possible for the worker to grip the handles 11 and manually move the component C held by the hand 1.

Next, as illustrated in FIGS. 7B and 7C, the worker grips the handles 11 and moves the hand 1 and the tip-end part 2a of the floating unit 2 to move the component C held by the hand 1 so that the target position P2 is explored (Step S60). In this embodiment, as illustrated in FIG. 7B, it is performed by moving the component C in the second directions D2 to align the component C with the position in the second directions D2 with respect to the target position P2, subsequently, as illustrated in FIG. 7C, moving the component C in the first directions D1 to align the component C with the position in the first directions D1 (height position) with respect to the target position P2, and, further, as further illustrated in FIG. 7D, by the worker shaking the component C through the hand 1 near the target position P2 while pressing the component C against the target position P2. Thus, the component C get into the target position P2, and the hand 1 and the component C held by the hand 1 can be located at the target position P2. Thus, since the floating unit 2 has the degree of freedom and the target position P2 is explored by shaking the component C near the target position P2 while pressing the component C against the target position P2, the assembling work of the component C can be performed quickly and the work efficiency is increased. Moreover, the hand can be located at the target position P2 even if the target position P2 varies.

Next, as illustrated in FIG. 7E, the worker fits the component C into the product T, and moves the hand 1 and the component C held by the hand 1 to the target position P2 (Step S70). Note that, at Step S60, when the hand 1 and the component C held by the hand 1 have already been located at the target position P2, Step S70 may be skipped. Thus, the component C can be assembled to the product T.

Then, when the component C is assembled to the product T, the worker operates the hand operating part 13 to input the releasing instruction of the component C, and the first hand controller 12 controls the hand 1 based on the releasing instruction to release the component C.

As described above, since the robot 100 of the present disclosure can independently move the hand 1 and the component C held by the hand 1 from the pre-assemble storage area Pa to the temporary target position P1 set near the target position P2, the worker's burden is reduced.

In addition, since the worker operates the floating unit 2 to move the hand 1 from the temporary target position P1 to the target position P2, the hand 1 can be located at the target position P2 even if the target position P2 varies.

Moreover, since the floating unit 2 of which the base-end part 32a is attached to the tip-end part 32b of the robot arm 32 has the plurality of joints, and the tip-end part is relatively movable with respect to the base-end part with two or more degrees of freedom, the worker can manually move the component C held by the hand 1 in the direction of at least one degree-of-freedom to explore the target position P2 at which the component C is attached, the worker can manually move the hand 1 and the component C held by the hand 1 to the target position P2 in the direction of another degree-of-freedom to assemble the component C to the product T. Therefore, the component C can be assembled to the product T after a worker tunes finely the position of the component C to the product T which requires experience and sense of a worker. Moreover, since a sensor which detects a worker's delicate assembling operation is not required, the structure of the system in which the worker cooperates with the robot is simplified, and it is advantageous to the manufacturing and the manufacturing cost is low.

### Embodiment 2

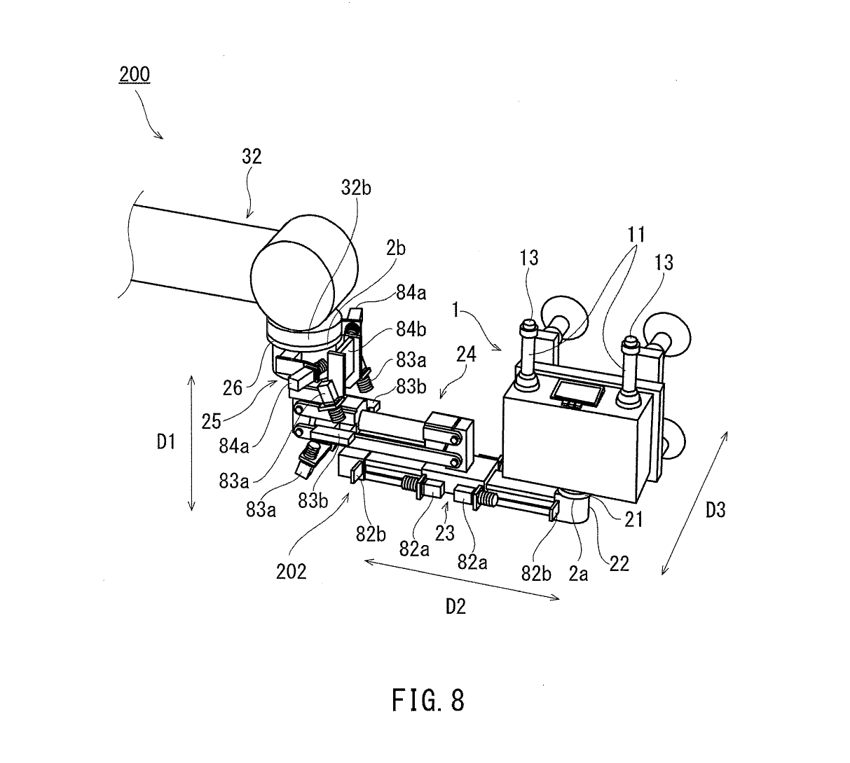

FIG. 8 is a perspective view illustrating one example of a structure of a floating unit 202 of a robot 200 according to Embodiment 2 of the present disclosure.

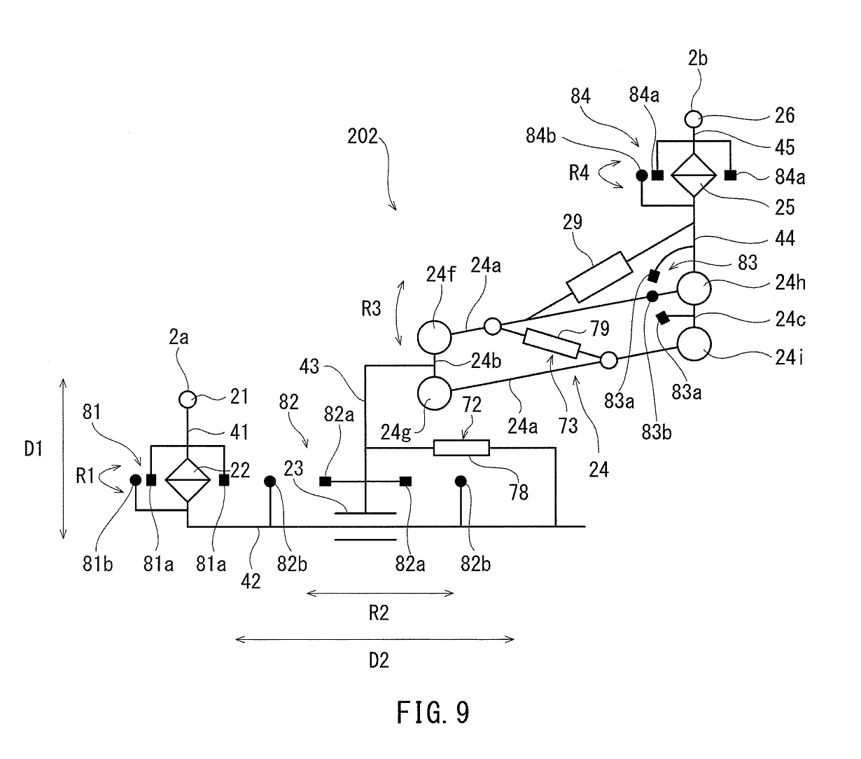

FIG. 9 is a view schematically illustrating one example of the structure of the floating unit 202.

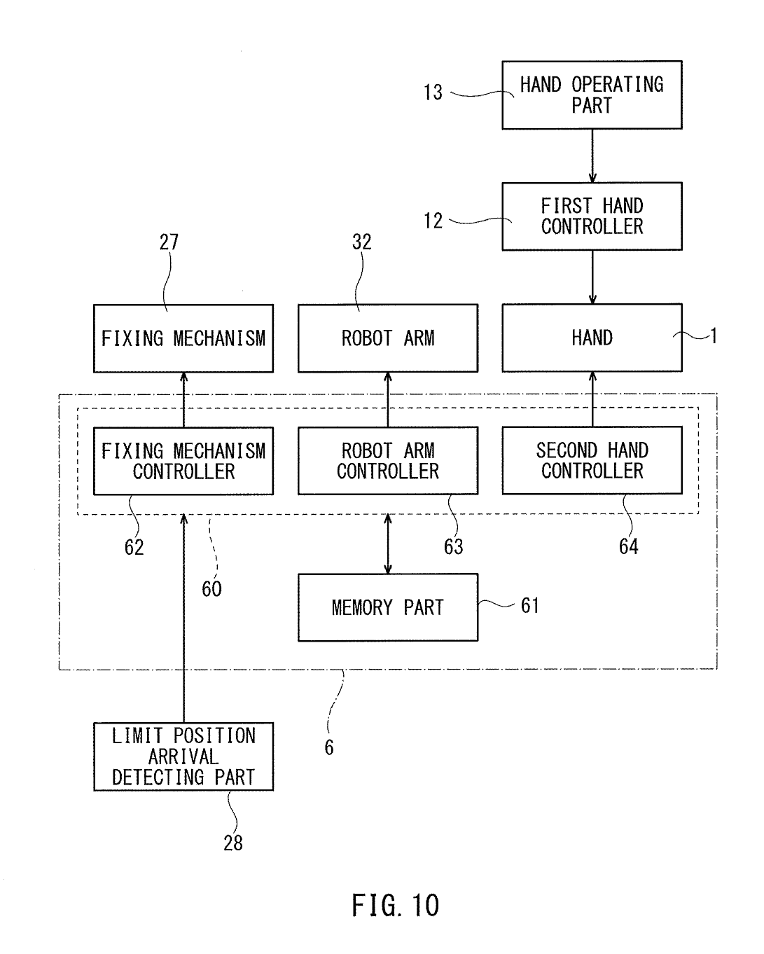

The floating unit 202 has a limit position arrival detecting part 28 (see FIG. 10).

The limit position arrival detecting part 28 detects that the joint of the floating unit 202 arrives at or reaches a limit position of a given section within the given operating range.

In this embodiment, the limit position arrival detecting part 28 includes, as illustrated in FIG. 9, first to fourth detecting parts 81, 82, 83 and 84 which correspond to the first to fourth joint parts 22 23, 24 and 25, respectively.

The first detecting part 81 includes a pair of spring sensors 81a attached to the second coupling piece 42, and a contactor 81b attached to the first coupling piece 41. One of the pair of spring sensors 81a is configured to contact the contactor 81b when the first coupling piece 41 is located at one of the limit positions of the operating range R1, and the other spring sensor 81a is configured to contact the contactor 81b when the first coupling piece 41 is located at the other limit position of the operating range R1. When one of the spring sensors 81a contacts the contactor 81b, the first detecting part 81 detects that the first joint part 22 reaches the limit position corresponding to the spring sensor 81a which detected the contact.

The second detecting part 82 includes a pair of spring sensors 82a attached to the third coupling piece 43, and a pair of contactors 82b attached to the second coupling piece 42. One of the pair of spring sensors 82a is configured to contact one of the pair of contactors 82b when the second coupling piece 42 is located at one of the limit positions of the operating range R2, and the other spring sensor 82a is configured to contact the other contactor 82b when the second coupling piece 42 is located at the other limit position of the operating range R2. When one of the spring sensors 82a contacts the contactor 82b, the second detecting part 82 detects that the second joint part 23 reaches the limit position corresponding to the spring sensor 82a which detected the contact.

The third detecting part 83 includes a pair of spring sensors 83a attached to the fourth coupling piece 44, and a contactor 83b attached to the third coupling piece 43. One of the pair of spring sensors 83a is configured to contact the contactor 83b when the third coupling piece 43 is located at one of the limit positions of the operating range R3, and the other spring sensor 83a is configured to contact the contactor 83b when the third coupling piece 43 is located at the other limit position of the operating range R3. When one of the spring sensors 83a contacts the contactor 83b, the third detecting part 83 detects that the third joint part 24 reaches the limit position corresponding to the spring sensor 83a which detected the contact.

The fourth detecting part 84 includes a pair of spring sensors 84a attached to the fifth coupling piece 45, and a contactor 84b attached to the fourth coupling piece 44. One of the pair of spring sensors 84a is configured to contact the contactor 84b when the fourth coupling piece 44 is located at one of the limit positions of the operating range R4, and the other spring sensor 84a is configured to contact the contactor 84b when the fourth coupling piece 44 is located at the other limit position of the operating range R4. When one of the spring sensors 84a contacts the contactor 84b, the fourth detecting part 84 detects that the fourth joint part 25 reaches the limit position corresponding to the spring sensor 84a which detected the contact.

Note that, although the spring sensors are provided at the limit positions of the operating ranges R1-R4, respectively in this embodiment, the spring sensors may be provided inward of the limit positions of the operating ranges R1-R4, respectively.

FIG. 10 is a view schematically illustrating one example of a structure of a control system of the robot 200.

As illustrated in FIG. 10, detection signals outputted from the limit position arrival detecting part 28 (the first to fourth detecting parts 81, 82, 83 and 84) are inputted into the controller 60.

### Example of Operation

Next, one example of operation of the robot 200 is described.

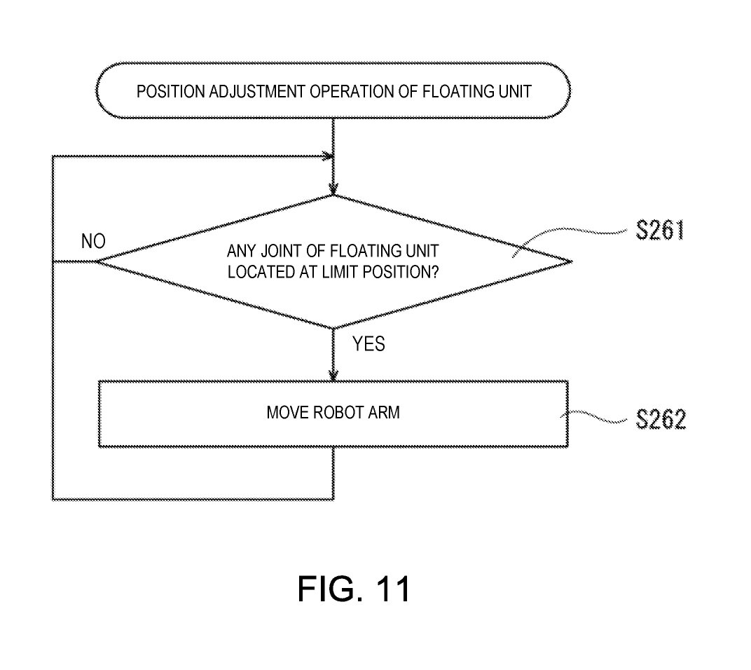

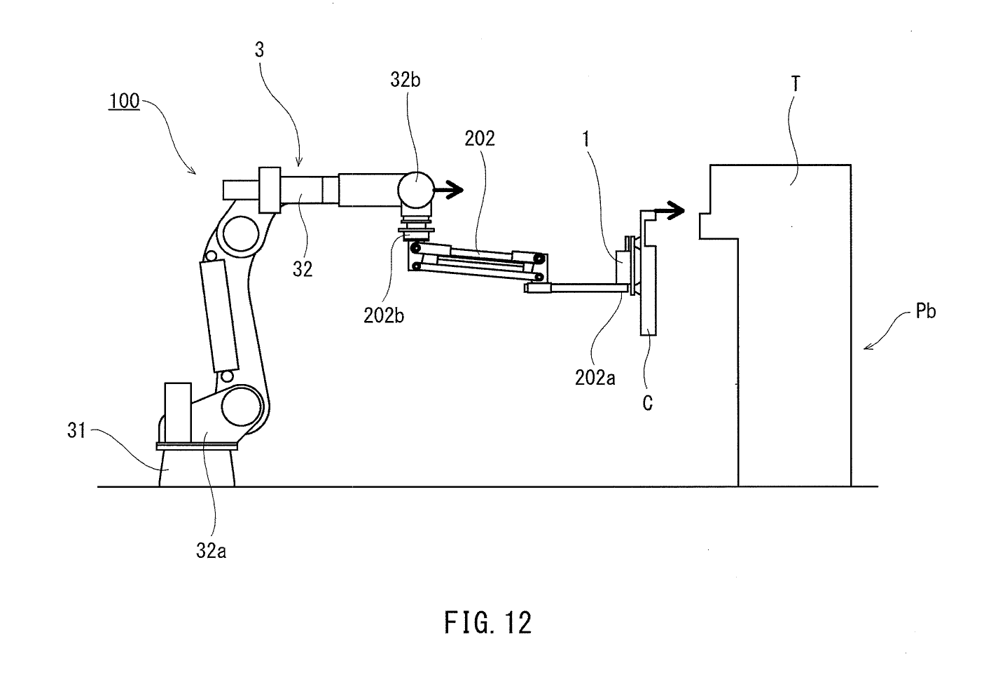

FIG. 11 is a flowchart illustrating the example of the operation of the robot 200. FIG. 12 is a view illustrating the example of the operation of the robot 200.

### Position Adjustment Operation of Floating Unit

At Step S60 of Embodiment 1 (see FIG. 6; in a state where the fixing mechanism 27 is deactivated after the component C is located at the temporary target position P1), when the target position P2 is not located within the moving range of a tip-end part 202a of the floating unit 202 located at the temporary target position P1 due to an error etc. in the position of the product T placed in the assembling area Pb, the robot 200 adjusts the position of the floating unit 202 as follows.

First, at Step S60 of Embodiment 1, when the worker moves the component C held by the hand 1, the posture of the floating unit 202 changes so that the plurality of joints of the floating unit 202 operate. Here, the controller 60 determines whether the limit position arrival detecting part 28 detects that at least one of the plurality of joints of the floating unit 202 reaches the limit position of the given section within the given operating range (Step S261). That is, the controller 60 determines whether the joint part corresponding to at least one of the first to fourth detecting parts 81, 82, 83 and 84 reaches the limit position.

If the controller 60 determines that none of the first to fourth joint parts 22, 23, 24 and 25 has reached the limit position (No at Step S261), the controller 60 again determines whether at least one of the first to fourth joint parts 22, 23, 24 and 25 reaches the limit position. That is, the controller 60 waits until at least one of the first to fourth joint parts 22, 23, 24 and 25 arrives at the limit position.

On the other hand, if the controller 60 determines that at least one of the first to fourth joint parts 22, 23, 24 and 25 has reached the limit position (Yes at Step S261), the robot arm controller 63 controls the robot arm 32 to move a base-end part 202b of the floating unit 202 (the robot-arm attaching part 26) in the moving directions of the hand 1 (the moving directions of the tip-end part 202a of the floating unit 202) by a given distance (Step S262).

That is, if the first detecting part 81 detects that the first joint part 22 reaches the limit position, the robot arm controller 63 controls the robot arm 32 to move the base-end part 202b of the floating unit 202 in the moving directions of the hand 1 (the first directions D1 and/or the third directions D3) by a given distance.

Moreover, if the second detecting part 82 detects that the second joint part 23 reaches the limit position, the robot arm controller 63 controls the robot arm 32 to move the base-end part 202b of the floating unit 202 in the moving directions of the hand 1 (the second directions D2) by a given distance.

Furthermore, if the third detecting part 83 detects that the third joint part 24 reaches the limit position, the robot arm controller 63 controls the robot arm 32 to move the base-end part 202b of the floating unit 202 in the moving directions of the hand 1 (the first directions D1) by a given distance.

Here, since the handles 11 of the hand 1 are gripped by the worker, the tip-end part 202a of the floating unit 202 and the hand 1 are not interlocked with the operation of the base-end part 202b of the floating unit 202, but the posture of the floating unit 202 changes. Thus, since the robot arm controller 63 moves the base-end part 202b of the floating unit 202 by the given distance to adjust the position of the floating unit 202, the tip-end part 202a of the floating unit 202 can be moved outside the moving range of the tip-end part 202a of the floating unit 202 at the time of moving the hand 1 so that the component C is located at the temporary target position P1. Therefore, due to the error etc. in the position of the product T placed in the assembling area Pb, the component C can be moved to the target position P2 even when the target position P2 is not located within the moving range of the tip-end part 202a of the floating unit 202 located at the temporary target position P1.

Then, the controller 60 again determines whether the joint part corresponding to at least one of the first to fourth detecting parts 81, 82, 83 and 84 reaches the limit position (Step S261). Thus, if the controller 60 again determines that the joint of the floating unit 2 has reached the limit position (Yes at Step S261), the robot arm controller 63 controls the robot arm 32 to move the base-end part 202b of the floating unit 202 (the robot-arm attaching part 26) in the moving directions of the hand 1 (the moving directions of the tip-end part 202a of the floating unit 202) by the given distance.

### Embodiment 3

Embodiment 1 is a mode in which the component C is assembled to the product T by using the robot 100; however, this embodiment is a mode in which the component C located at a given position is held and conveyed by the robot 100.

In this embodiment, the target position is a position at which the component C placed in the pre-assemble storage area Pa is located. The temporary target position is set as a position where the hand 1 can hold the component C by relatively moving the tip-end part 2a of the floating unit 2 located at the temporary target position with respect to the base-end part 2b to move the hand 1 to the target position.

### Example of Operation

Next, one example of operation of the robot 100 is described.

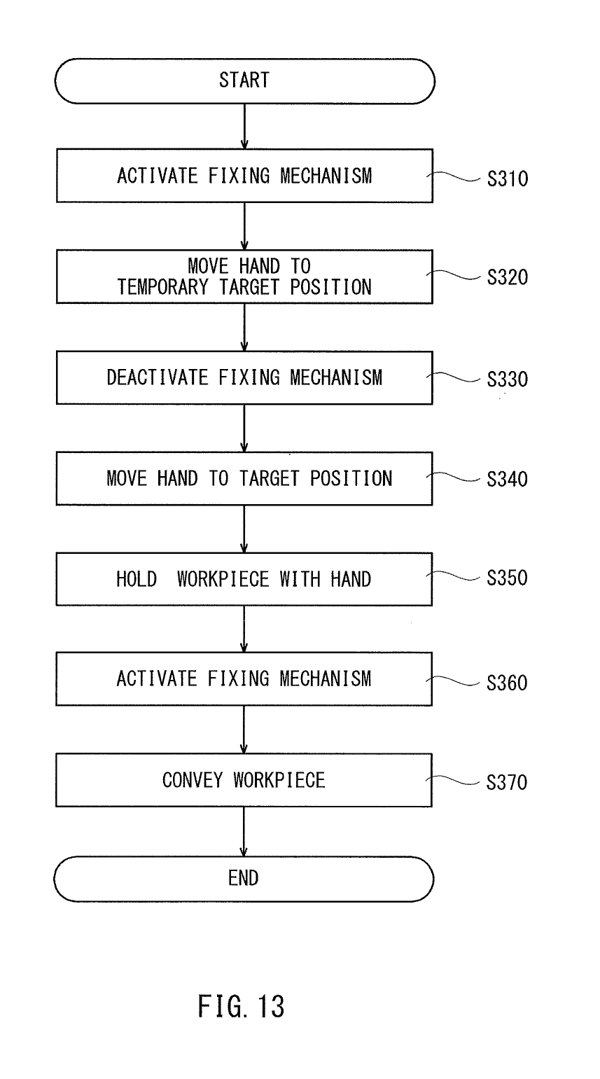

FIG. 13 is a flowchart illustrating one example of the operation of the robot 100 according to Embodiment 3.

First, the fixing mechanism controller 62 enables the fixing mechanism 27 to regulate the relative movement of the tip-end part 2a of the floating unit 2 with respect to the base-end part 2b, and fix the spatial relationship between the tip-end part 32b of the robot arm 32 and the hand 1 which are coupled via the floating unit 2 to a given spatial relationship (Step S310).

Next, the robot arm controller 63 controls the robot arm 32 to move the hand 1 to the temporary target position P1 based on the information for identifying the position of the temporary target position P1 stored in the memory part 61 (Step S320).

Then, the fixing mechanism controller 62 deactivates the fixing mechanism 27 (Step S330). Thereby, the relative movement of the tip-end part 2a of the floating unit 2 with respect to the base-end part 2b is permitted so that the worker is able to grip the handles 11 and manually move the hand 1.

Next, the worker grips the handles 11 and moves the hand 1 to locate the hand 1 at the target position P2 where the component C is located (Step S340). Here, since the worker can visually confirm the position of the component C (the target position P2) and move the hand 1 to the target position P2, the hand 1 can quickly be located at the position where the component C is located and the work efficiency is increased, even when the position of the component C varies.

Next, the worker operates the hand operating part 13 to input the holding instruction of the component C, and the first hand controller 12 controls the hand 1 based on the holding instruction to hold the component C (Step S350).

Next, the fixing mechanism controller 62 enables the fixing mechanism 27 (Step S360).

Next, the robot arm controller 63 controls the robot arm 32 to convey the component C (Step S370).

Thus, by using the robot 100, the hand 1 can quickly be moved to the position where the component C is located and the component C can be held by the hand 1 even when the component C placed in the pre-assemble storage area Pa varies. Thus, the efficiency of the conveyance work of the component C is increased.

For a person skilled in the art, many improvements and other embodiments of the present disclosure are apparent from the above description. Therefore, the above description is to be interpreted merely as illustration, and it is provided in order to teach a person skilled in the art the best mode which implements the present disclosure. Details of the structure and/or function may be substantially changed without departing from the spirit of the present disclosure.

### DESCRIPTION OF REFERENCE CHARACTERS

C: Workpiece
T: Assembling Object
D1: First Directions
D2: Second Directions
D3: Third Directions
P1: Temporary Target Position
P2: Target Position
Pa: Pre-assemble Storage Area
Pb: Assembling Area
R1: Operating Range
R2: Operating Range
R3: Operating Range
R4: Operating Range
1: Hand
2: Floating Unit
2a: Tip-end Part (of Floating Unit)
2b: Base-end Part (of Floating Unit)
3: Robot Body
6: Control Device
11: Handle
12: First Hand Controller
13: Hand Operating Part
21: Hand Attaching Part
22: First Joint Part
23: Second Joint Part
24: Third Joint Part
24a: Pivot Link (of Third Joint Part)
24b: Tip-end Side Coupling Part (of Third Joint Part)
24c: Base-end Side Coupling Part (of Third Joint Part)
25: Fourth Joint Part
26: Robot-arm Attaching Part
27: Fixing Mechanism
28: Limit Position Arrival Detecting Part
29: Balancer Mechanism
31: Robot Base
32: Robot Arm
32a: Base-end Part (of Robot Arm)
32b: Tip-end Part (of Robot Arm)
41: First Coupling Piece
42: Second Coupling Piece
43: Third Coupling Piece
44: Fourth Coupling Piece
45: Fifth Coupling Piece
60: Controller
61: Memory Part
62: Fixing Mechanism Controller
63: Robot Arm Controller
64: Second Hand Controller
71: First Fixing Part
72: Second Fixing Part
73: Third Fixing Part
74: Fourth Fixing Part
76: Arm
77: Arm Pinching Part
78: Air Cylinder Mechanism
79: Air Cylinder Mechanism
81: First Detecting Part
81a: Spring Sensor (of First Detecting Part)
81b: Contactor (of First Detecting Part)
82: Second Detecting Part
82a: Spring Sensor (of Second Detecting Part)
82b: Contactor (of Second Detecting Part)
83: Third Detecting Part
83a: Spring Sensor (of Third Detecting Part)
83b: Contactor (of Third Detecting Part)
84: Fourth Detecting Part
84a: Spring Sensor (of Fourth Detecting Part)
84b: Contactor (of Fourth Detecting Part)
100: Robot

1. A robot, comprising:
a hand configured to hold a workpiece;
a floating unit having a tip-end part and a base-end part and having a joint configured to operate within a given operating range, the hand being attached to the tip-end part, and the tip-end part being relatively movable with respect to the base-end part;
a robot arm of which a tip-end part is attached to the base-end part of the floating unit and configured to move the hand and the floating unit; and
a control device having a robot arm controller configured to control operation of the robot arm,
wherein the robot arm controller moves the hand and the floating unit so that the hand is located at a temporary target position, and
wherein the temporary target position is a position from which the hand is movable to a target position by relatively moving the tip-end part of the floating unit with respect to the base-end part thereof, the tip-end part located at the temporary target position.

2. The robot of claim 1, wherein the floating unit has a plurality of joints configured to operate within the given operating range, and the tip-end part is relatively movable with respect to the base-end part with two or more degrees of freedom.

3. The robot of claim 1, further comprising a fixing mechanism configured to regulate operation of the joint by being active and permit the operation of the joint by being inactive,
wherein the control device has a fixing mechanism controller configured to control operation of the fixing mechanism, and
wherein the fixing mechanism controller activates the fixing mechanism when the robot arm controller moves the hand and the floating unit so that the hand is located at the temporary target position.

4. The robot of claim 3, wherein the fixing mechanism moves the tip-end part of the floating unit by being active so that the floating unit takes a given posture, and maintains the given posture.

5. The robot of claim 4, wherein the floating unit includes a limit position arrival detecting part configured to detect that the joint reaches a limit position of a given section within the given operating range, and
wherein the fixing mechanism controller deactivates the fixing mechanism after the robot arm controller moves the hand to the temporary target position, and in a state where the fixing mechanism is deactivated, when the limit position arrival detecting part detects that the joint reaches the limit position of the movable range, the robot arm controller moves the base-end part of the floating unit in a moving direction of the tip-end part of the floating unit by a given distance.

6. The robot of claim 1, wherein the workpiece is a component assembled to a product, and
wherein the target position is a position at which the component is located in a state where the component is assembled to the product.

7. The robot of claim 1, wherein the joint of the floating unit has a degree of freedom in the gravity direction, and
wherein the floating unit has a balancer configured to exert a force in the joint in a direction opposite from a force exerted in the joint by gravity.

8. A method of controlling a robot, the robot including:
a hand configured to hold a workpiece;
a floating unit having a tip-end part and a base-end part and having a joint configured to operate within a given operating range, the hand being attached to the tip-end part, and the tip-end part being relatively movable with respect to the base-end part;
a robot arm of which a tip-end part is attached to the base-end part of the floating unit and configured to move the hand and the floating unit; and
a control device having a robot arm controller configured to control operation of the robot arm,
wherein the robot arm controller moves the hand and the floating unit so that the hand is located at a temporary target position, and
wherein the temporary target position is a position from which the hand is movable to a target position by relatively moving the tip-end part of the floating unit with respect to the base-end part thereof, the tip-end part located at the temporary target position.

9. The method of claim 8, wherein the floating unit has a plurality of joints configured to operate within the given operating range, and the tip-end part is relatively movable with respect to the base-end part with two or more degrees of freedom.

10. The method of claim 8, the robot further including a fixing mechanism configured to regulate operation of the joint by being active and permit operation of the joint by being inactive,
wherein the control device has a fixing mechanism controller configured to control operation of the fixing mechanism, and
wherein the fixing mechanism controller activates the fixing mechanism when the robot arm controller moves the hand and the floating unit so that the hand is located at the temporary target position.

11. The method of claim 10, wherein the fixing mechanism moves the tip-end part of the floating unit by being active so that the floating unit takes a given posture, and maintains the given posture.

12. The method of claim 11, wherein the floating unit includes a limit position arrival detecting part configured to detect that the joint reaches a limit position of a given section within the given operating range, and
wherein the fixing mechanism controller deactivates the fixing mechanism after the robot arm controller moves the hand to the temporary target position, and in a state where the fixing mechanism is deactivated, when the limit position arrival detecting part detects that the joint reaches the limit position of the movable range, the robot arm controller moves the base-end part of the floating unit in a moving direction of the tip-end part of the floating unit by a given distance.

13. The method of claim 8, wherein the workpiece is a component assembled to a product, and
wherein the target position is a position at which the component is located in a state where the component is assembled to the product.

14. The method of claim 8, wherein the joint of the floating unit has a degree of freedom in the gravity direction, and
wherein the floating unit has a balancer configured to exert a force in the joint in a direction opposite from a force exerted in the joint by gravity.

15. A method of assembling a workpiece to an assembling object by using a robot, the robot including:
a hand configured to hold a workpiece;
a floating unit having a tip-end part and a base-end part and having a joint configured to operate within a given operating range, the hand being attached to the tip-end part, and the tip-end part being relatively movable with respect to the base-end part;
a robot arm of which a tip-end part is attached to the base-end part of the floating unit and configured to move the hand and the floating unit; and
a control device having a robot arm controller configured to control the robot arm,
wherein the robot arm controller moves the hand and the floating unit so that the hand is located at a temporary target position, and
wherein, by a worker relatively moving the tip-end part of the floating unit with respect to the base-end part, the workpiece held by the hand located at the temporary target position is moved to a destination of the workpiece and is assembled to the assembling object.

16. A method of conveying a workpiece located at a given position by using a robot, the robot including:
a hand configured to hold a workpiece;
a floating unit having a tip-end part and a base-end part and having a joint configured to operate within a given operating range, the hand being attached to the tip-end part, and the tip-end part being relatively movable with respect to the base-end part;
a robot arm of which a tip-end part is attached to the base-end part of the floating unit and configured to move the hand and the floating unit; and
a control device having a robot arm controller configured to control the robot arm,
wherein the robot arm controller moves the hand and the floating unit so that the hand is located at a temporary target position,
wherein a worker relatively moves the tip-end part of the floating unit with respect to the base-end part to move the hand located at the temporary target position to the given position, and causes the hand to hold the workpiece, and
wherein the robot arm controller moves the hand and the floating unit to convey the workpiece held by the hand.
